(19) United States
(12) Patent Application Publication
(10) Pub. No.: US 2016/0155167 A1
(43) Pub. Date: Jun. 2, 2016

(54) MEDICAL SOFTWARE SELLING METHOD

(71) Applicant: Infinitt Healthcare Co., Ltd., Seoul (KR)

(72) Inventors: Jee-Hye KIM, Seoul (KR); Hee-Jin LIM, Seoul (KR); Sarah-Lena Vonderberg, Seoul (KR)

(21) Appl. No.: 14/603,368

(22) Filed: Jan. 23, 2015

(30) Foreign Application Priority Data
Nov. 29, 2014 (KR) 10-2014-0169244
Jan. 21, 2015 (KR) 10-2015-0010206

(51) Int. Cl. G06Q 30/06; G06Q 20/10; G06F 19/00

(52) U.S. Cl. CPC G06Q 30/0611; G06F 19/327; G06Q 20/102

(57) ABSTRACT

Provided is a medical software selling method which includes: a selling medical software displaying step of displaying a plurality of medical software pieces to be sold in a medical software store; a desired medical software inquiry receiving step of receiving an inquiry about desired medical software of the plurality of medical software pieces from a client terminal; a desired medical software sales information checking step of privately checking sales information on the desired medical software; and a desired medical software purchase request receiving step of receiving a purchase request of the desired medical software from the client terminal.

### CROSS-REFERENCE TO RELATED APPLICATION

This application claims priority to and the benefit of Korean Patent Application No. 10-2014-0169244 filed on Nov. 29, 2014, and Korean Patent Application No. 10-2015-0010206 filed on Jan. 21, 2015, the disclosures of which are incorporated by reference herein in their entireties.

### BACKGROUND

1. Technical Field

The present invention relates to a medical software selling method, and more particularly, to a medical software selling method of receiving a private input of sales information on desired medical software from a client terminal in a medical software store of a new concept, privately transmitting the sales information on the desired medical software to the client terminal, selling the medical software on the basis thereof, and privately transmitting update information of the purchased software and the like to the client terminal.

2. Discussion of Related Art

The App Store is an abbreviation of “application store” and is a virtual marketplace in which Apple has provided iPhone and iPod touch application download services after launching iPhone 3G which is a smart phone.

A medical software store has never been present.

### SUMMARY

The present invention is directed to a medical software selling method using a new medical software store.

Particularly, the present invention is directed to a medical software selling method of receiving a private input of sales information on desired medical software from a client terminal in a new medical software store, privately transmitting the sales information on the desired medical software to the client terminal, and selling the medical software on the basis thereof.

According to an aspect of the present invention, there is provided, a medical software selling method including: a selling medical software displaying step of displaying a plurality of medical software pieces to be sold in as medical software store; a desired medical software inquiry receiving step of receiving an inquiry about desired medical software of the plurality of medical software pieces from a client terminal; a desired medical software sales information checking step of privately checking sales information on the desired medical software; and a desired medical software purchase request receiving step of receiving as purchase request of the desired medical software from the client terminal.

The desired medical software sales information checking step may include: a desired medical software sales information inputting step of inputting the sales information on the desired medical software; and a desired medical software sales information transmitting step of privately transmitting the sales information on the desired medical software to the client terminal.

The sales information may include one or more of a selling price, a sales volume, and a sales discount rate.

The desired medical software sales information transmitting step may include: enabling check of the sales information on the desired medical software only when the client terminal is authenticated or logs in: or transmitting the sales information on the desired medical software to an E-mail address designated by the client terminal.

The desired medical software sales information inputting step may be performed by an administrator of the medical software store.

Only when the sales information on the desired medical software has been input, an attribute of the desired medical software may be switched so as to allow the purchase request of the desired medical software when the client terminal having transmitted the inquiry about the desired medical software is authenticated or logs in, or an attribute of the desired medical software may be switched so as to allow the purchase request of the desired medical software when the sales information on the desired medical software is transmitted to an E-mail address designated by the client terminal having transmitted the inquiry about the desired medical software.

The switching of the attribute of the desired medical software may include switching an inquiry button about the desired medical software to a purchase button.

The medical software selling method may further include a desired medical software paying step of paying for the desired medical software, and the desired medical software paying step may be performed at the same time as performing the desired medical software purchase request receiving step or after performing the desired medical software purchase request receiving step.

An attribute of the purchased medical software may be switched so as to allow downloading or installing of the purchased medical software after performing the desired medical software paying step.

Only when the sales information on the desired medical software has been input, an attribute of the desired medical software may be switched so as to allow the purchase request of the desired medical software when the client terminal having transmitted the inquiry about the desired medical software is authenticated or logs in or an attribute of the desired medical software may be switched so as to allow the purchase request of the desired medical software when the sales information on the desired medical software is transmitted to an E-mail address designated by the client terminal having transmitted the inquiry about the desired medical software, the switching of the attribute of the desired medical software may include switching an inquiry button about the desired medical software to a purchase button, an attribute of the purchased medical software may be switched so as to allow downloading or installing of the purchased medical software after performing the desired medical software paying step, and the switching of the attribute of the purchased medical software may include switching a purchase button of the purchased medical software to a download button or an installation button.

The medical software may be software or an application that can be downloaded or installed in one or more of a server, a computer, a mobile terminal, a portable terminal, a mobile phone, and a tablet.

The medical software selling method may further include a step of inputting a license number enabling the purchased medical software to be executed when the purchased medical software is downloaded or installed.

One or more of the possible number of times of download or installation, the possible number of terminals for download or installation, and a possible period of re-download or re-installation may vary depending on the purchased medical software when the purchased medical software is downloaded or installed.

The medical software selling method may further include a purchased medical software update enabling message checking step of privately chocking an update enabling message tot the purchased medical software when it is determined that an update of the purchased medical software is present after the purchased medical software is downloaded or installed.

The purchased medical software update enabling message checking step may include: displaying the update enabling message of the purchased medical software when the client terminal is authenticated or logs in; or transmitting the update enabling message for the purchased medical software to an E-mail address designated by the client terminal.

In the medical software selling method according to the aspect of the invention, when sales information on desired medical software is privately input from a client terminal in a medical software store of a new concept, the sales information on the desired medical software is privately transmitted to the client terminal, the medical software is sold on the basis thereof, and update information of the purchased software and the like is privately transmitted to the client terminal.

Accordingly, in the medical software field which is a special field, an administrator of the medical software store or vendors can maintain their sales policies and it is possible to prevent their bargaining power with consumers (hospitals, doctors, and the like) from being lowered.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a flowchart illustrating a medical software selling method according to an exemplary embodiment of the present invention.

### DETAILED DESCRIPTION OF EXEMPLARY EMBODIMENTS

Exemplary embodiments of the present invention will be described in detail below with reference to the accompanying drawings. Terms or words used in this description or the appended claims should not be analyzed to have general or dictionary meanings, but should be analyzed to have meanings and concepts corresponding to the technical spirit of the present invention, on the basis of the principle that an inventor can appropriately define concepts of terms for the purpose of explaining the present invention in a best mode.

Therefore, embodiments described in this description and the configurations illustrated in the drawings ate merely best exemplary embodiments of the present invention and do not represent all the technical spirit of the present invention. Accordingly, it should be understood by those skilled in the art that there may be various equivalents and modifications with which the exemplary embodiments can be replaced at the time of filing of the present invention.

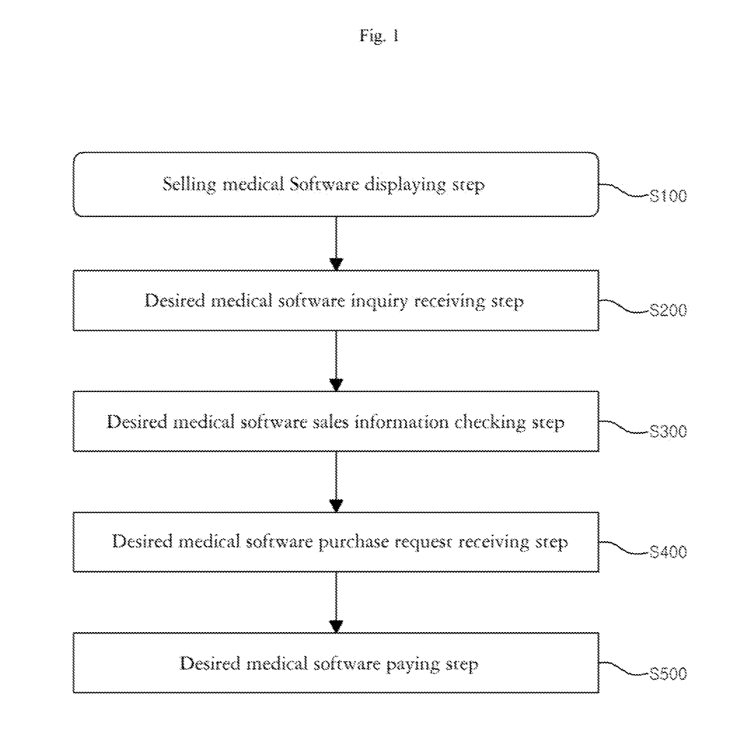

FIG. 1 is a flowchart illustrating a medical software selling method according to an exemplary embodiment of the present invention.

As illustrated in FIG. 1, a medical software selling method according to the present invention includes a selling medical software displaying step (S100), a desired medical software inquiry receiving step (S200), a desired medical software sales information checking step (S300), a desired medical software purchase request receiving step (S400), and a desired medical software paying step (S500).

First, in the selling medical software displaying step (S100), a plurality of medical software pieces to be sold are displayed in a medical software store. Here, the medical software may be software or an application that can be downloaded or installed in one or more of as server, a computer, a mobile terminal, a portable terminal, a mobile phone, and a tablet. The medical software store means a store in which principal information of the plurality of medical software pieces is uploaded or displayed and an inquiry, a request for sales information, a purchase, or a payment by a client terminal are enabled. Such a medical software store has not been yet present.

Then, in the desired medical software inquiry receiving step (S200), an inquiry about desired medical software o the plurality of medical software pieces is received from a client terminal.

Then, in the desired medical software sales information checking step (S300), sales information on the desired medical software is privately checked. Here, the desired medical software sales information checking step (S300) includes a desired medical software sales information inputting step of inputting the sales information on the desired medical software and a desired medical software sales information transmitting step of privately transmitting the sales information on the desired medical software to the client terminal.

The desired medical software sales information inputting step is generally performed by an administrator of the medical software store. However, in some cases, when a plurality of medical software producing companies or vendors are present in the medical software store, administrators of the plurality of medical software producing companies or vendors in the medical software store may input sales information. In some cases, a client terminal privately having received sales information may input the sales information.

In this case, the desired medical software sales information transmitting step includes enabling check of the sales information on the desired medical software only when the client terminal is authenticated or logs in; or transmitting the sales information on the desired medical software to an E-mail address designated by the client terminal. Accordingly, only the client terminal having selected the desired medical software can privately check the sales Information on the desired medical software.

Accordingly, in the medical software field which is a special field, an administrator of the medical software store or vendors can maintain their sales policies and it is possible to prevent their bargaining power with consumers (hospitals, doctors, and the like) from being lowered.

Here, the sales information of medical software includes one or more of a selling price, as sales volume, and a sales discount rate.

Only when the sales information on the desired medical software has been input, an attribute of the desired medical software may be switched so as to allow the purchase request of the desired medical software when the client terminal having transmitted the inquiry about the desired medical software is authenticated or logs in. Alternatively, the attribute of the desired medical software may be switched so as to allow the purchase request of the desired medical software when the sales information on the desired medical software is transmitted to an E-mail address designated by the client terminal having transmitted the inquiry about the desired medical software. Here, the switching of the attribute of the desired medical software may include switching an inquiry button about the desired medical software to a purchase button.

Then, in the desired medical software purchase request receiving step (S400), a purchase request of the desired medical software is received from the client terminal. In a desired medical software paying step (S500), the desired medical software is paid for purchase.

Here, the desired medical software paying step of paying for the desired medical software may be performed at the same time as performing the desired medical software purchase request receiving step or after performing the desired medical software purchase request receiving step.

The attribute of the purchased medical software may be switched so as to allow downloading or installing of the purchased medical software after performing the desired medical software paying step.

The switching of the attribute of the purchased medical software may include switching a purchase button of the purchased medical software to as download button or an installation button.

The medical software selling method may further include a step of inputting a license number enabling the purchased medical software to be executed when the purchased medical software is downloaded or installed.

One or more of the possible number of times of download or installation, the possible number of terminals for download or installation, and a possible period of re-download or re-installation may vary depending on the purchased medical software when the purchased medical software is downloaded or installed.

The medical software selling method may further include a purchased medical software update enabling message checking step of privately checking an update enabling message fir the purchased medical software when it is determined that an update of the purchased medical software is present after the purchased medical software is downloaded or installed.

The purchased medical software update enabling message checking step may include displaying the update enabling message of the purchased medical software when the client terminal is authenticated or logs in or transmitting the update enabling message for the purchased medical software to an E-mail address designated by the client terminal.

While the invention has been shown and described with reference to certain exemplary embodiments thereof it will be understood by those skilled in the art that various changes in form and details may be made therein without departing from the scope of the invention as defined by the appended claims.

What is claimed:

1. A medical software selling method comprising:
a selling medical software displaying step of displaying a plurality of medical software pieces to be sold in a medical software store;
a desired medical software inquiry receiving step of receiving an inquiry about desired medical software of the plurality of medical software pieces from a client terminal;
a desired medical software sales information checking step of privately checking sales information on the desired medical software; and
a desired medical software purchase request receiving step of receiving a purchase request of the desired medical software from the client terminal.

2. The medical software selling method according to claim 1, wherein the desired medical software sales information checking step includes:
a desired medical software sales information inputting step of inputting the sales information on the desired medical software; and
a desired medical software sales information transmitting step of privately transmitting the sales information on the desired medical software to the client terminal.

3. The medical software selling method according to claim 1, wherein the sales information includes one or more of a selling price, a sales volume, and a sales discount rate.

4. The medical software selling method according to claim 2, wherein the desired medical software sales information transmitting step includes:
enabling check of the sales information on the desired medical software only when the client terminal is authenticated or logs in; or
transmitting the sales information on the desired medical software to an E-mail address designated by the client terminal.

5. The medical software selling method according to claim 2, wherein the desired medical software sales information inputting step is performed by an administrator of the medical software store.

6. The medical software selling method according to claim 2, wherein only when the sales information on the desired medical software has been input,
an attribute of the desired medical software is switched so as to allow the purchase request of the desired medical software when the client terminal having transmitted the inquiry about the desired medical software is authenticated or logs in, or
an attribute of the desired medical software is switched so as to allow the purchase request of the desired medical software when the sales information on the desired medical software is transmitted to an E-mail address designated by the client terminal haying transmitted the inquiry about the desired medical software.

7. The medical software selling method according to claim 6, wherein the switching of the attribute of the desired medical software includes switching an inquiry button about the desired medical software to a purchase button.

8. The medical software selling method according to claim 1, further comprising a desired medical software paying step of paying for the desired medical software.
wherein the desired medical software paying step is performed at the same time as performing the desired medical software purchase request receiving step or after performing the desired medical software purchase request receiving step.

9. The medical software selling method according to claim 8, wherein an attribute of the purchased medical software is switched so as to allow downloading or installing of the purchased medical software after performing the desired medical software paying step.

10. The medical software selling method according to claim 9, wherein only when the sales information on the desired medical software has been input,
an attribute of the desired medical software is switched so as to allow the purchase request of the desired medical software when the client terminal having transmitted the inquiry about the desired medical software is authenticated or logs in, or
an attribute of the desired medical software is switched so as to allow the purchase request of the desired medical software when the sales information on the desired medical software is transmitted to an E-mail address designated by the client terminal having transmitted, the inquiry about the desired medical software,
wherein the switching of the attribute of the desired medical software includes switching an inquiry button about the desired medical software to a purchase button,
wherein an attribute of the purchased medical software is switched so as to allow downloading or installing of the purchased medical software after performing the desired medical software paying step, and
wherein the switching of the attribute of the purchased medical software includes witching a purchase button of the purchased medical software to a download button or an installation button.

11. The medical software selling method according to claim 1, wherein the medical soft is software or an application that can be downloaded or installed in one or more of a server, a computer, a mobile terminal, a portable terminal, a mobile phone, and a tablet.

12. The medical software selling method according to claim 9, further comprising a step of inputting a license number enabling the purchased medical software to be executed when the purchased medical software is downloaded or installed.

13. The medical software selling method according to claim 9, wherein one or more of the possible number of times of download or installation, the possible number of terminals for download or installation, and a possible period of re-download or re-installation vary depending on the purchased medical software when the purchased medical so ft w are is down loaded or installed.

14. The medical software selling method according to claim 9, further comprising a purchased medical software update enabling message checking step of privately checking an update enabling message for the purchased medical software when it is determined that an update of the purchased medical software is present after the purchased medical software is downloaded or installed.

15. The medical software selling method according to claim 14, wherein the purchased medical software update enabling message checking step includes:
displaying the update enabling message of the purchased medical software when the client, terminal is authenticated or logs in; or
transmitting the update enabling message for the purchased medical software to an E-mail address designated by the client terminal.
